(19) United States
(12) Patent Application Publication
(10) Pub. No.: US 2007/0023408 A1
(43) Pub. Date: Feb. 1, 2007

(54) Welding system and method

(75) Inventor: Simon Chu Yuk Man, Taipo (HK)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SINO GOLF MANUFACTURING CO., LTD., New Territories (CN)

(21) Appl. No.: 11/194,219

(22) Filed: Aug. 1, 2005

(51) Int. Cl. B23K 9/12

(52) U.S. Cl. 219/124.34; 219/130.21; 219/125.1

(57) ABSTRACT

A welding system for welding one or more work pieces, the system comprising a welding device, a laser tracking device, and a controller module. In use of the welding system, the laser tracking device tracks a path of a desired weld and detects real-time variation(s) in the weld path. The variation(s) is/are assessed by the controller module to provide real-time communication with the welding system, so as to adjust one or more welding operating parameters.

The present invention relates to a welding system and method for welding one or more work pieces. In particular, the present invention relates to welding one or more parts which together form at least part of a head of a golf club and, preferably, the whole of a head of a golf club.

Welding of one or more work pieces which make up, at least partially, the head of a golf club is known in the art. In the past, welding has been carried out by humans controlling the welding system, including detection of variations in a weld path (desired location of weld) and altering welding operating parameters to counteract the detected variations. Detection has, naturally, been carried out by a user seeing the variations and then making appropriate alterations to the welding operating parameters. In addition, alteration of the path of a welding device during welding was also carried out by a user and involved great hand-eye co-ordination to achieve a high quality weld—usually at the expense of speediness. Unfortunately, it can be seen easily that the quality of the weld produced may be affected by human error, for example, by poor judgement of the variations, which may be caused by negligence, tiredness or absent mindedness, for example. Accordingly, relatively poor quality welds are often produced. It is also known in the art to attempt to produce better quality welds by using robotic arms controlled directly by users. Although the manner in which the welding device is held is different, human error still plays a large part in the relatively poor quality welds produced by this method. As the quality of the welds produced by both methods are relatively low, there is a lot of wastage of materials, as some welded golf club heads are of a standard too low for sale. In addition, both prior art methods are relatively slow.

Therefore, there is a need to produce a welding system which substantially alleviates the disadvantages of the prior art methods.

Accordingly, in a first aspect the present invention provides a welding system for welding one or more work pieces, the system comprising:

a welding device;

a laser tracking device; and

a controller module,

wherein, in use of the welding system, the laser tracking device tracks a path of a desired weld and detects

real-time variations(s) in the weld path, which variation(s) is/are assessed by the controller module to provide

real-time communication with the welding system, so as to adjust one or more welding operating parameters.

Preferably, the real-time variations is/are selected from location, path, size, orientation, depth and/or shape of the weld to be produced.

Additionally, the welding operating parameters are selected from current or voltage supplied to an arc welder, wire feed rate, torch and/or inert gas flow rate, distance of arc from the weld path of the one or more work pieces, tracking of welding device along the weld path, speed of movement of the welding device, and width, depth and/or shape of weld produced.

The welding device may be an arc welder or gas welder. When the welding device is an arc welder, it is capable of MIG, laser, plasma or TIG welding. Preferably, the welding device further comprises a wire feeder.

The laser tracking device is, preferably, a Servo Robot MINI-I 60 and comprises a laser sensor (laser camera) and a control unit. The laser sensor determines the distance of arc from the weld path of the one or more work pieces, width, depth and/or shape of weld to be produced and tracks a desired weld path. Information relating to those welding operating parameters is fed to the controller module.

The laser tracking device and/or the welding device may be located upon a movable armature, such as a robotic arm. In preference, the laser tracking device is mounted to a front of the armature and the welding device is mounted to a rear of the armature.

An inert gas is used at the point of welding to prevent oxidation during welding of the one or more work pieces. Preferably, the inert gas is argon.

The welding system may further comprise one or more work pieces which are fitable together, to provide a unitary piece after welding. Preferably, the one or more work pieces are fitable together to provide at least part of a head of a golf club and, most preferably, the whole head of a golf club.

The welding system may further comprise an auto feeder or conveyor, for supplying one or more work pieces, and a fixture for location of the one or more work pieces for welding.

In a second aspect, the invention provides a method of welding one or more work pieces comprising, providing a welding device; a laser tracking device; a controller module; and one or more work pieces, wherein during welding, the laser tracking device tracks a path of desired weld on the one or more work pieces and detects real-time variations in the weld path, data relating to the real-time variations is assessed by the controller module which provides real-time instructions to the welding system to adjust one or more welding operating parameters.

Advantageously, the welding system and method of the present invention provide for improved quality welds over prior art systems and methods. Further, the improved quality is provided in a speedy manner with a reduction in wastage of consumables. In addition, the system and method of the present invention provide for real-time adjustment or alteration of the location, size, orientation, depth and/or shape of the weld to be produced.

In the description and claims, the phrase real-time is used to indicate a near-instantaneous action or reaction. In particular, the phrase is used to describe a system and method which analyses data signals received from a detector device and adapts the system and method, in accordance with the data signals, to achieve an improved result without a significant time delay in acting on, or reacting to, the data signals. As such, the system and method of the present invention provide for a near-instantaneous action on, or reaction to, the variations detected in the weld path by the laser tracking device, so that welding operating parameters can be optimised for welding the weld path detected. Further, the term weld path will be understood to mean the path or line between the one or more pieces along which path or line a welded joint should be formed.

Preferred embodiments of the present invention will now be described, by way of example only, with reference to the accompanying drawings, in which:

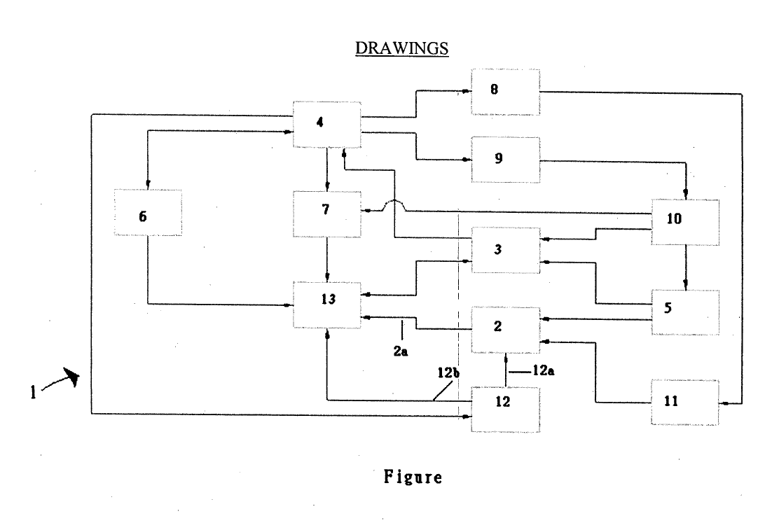

FIG. 1 is a schematic block diagram of a welding system and method according to the present invention;

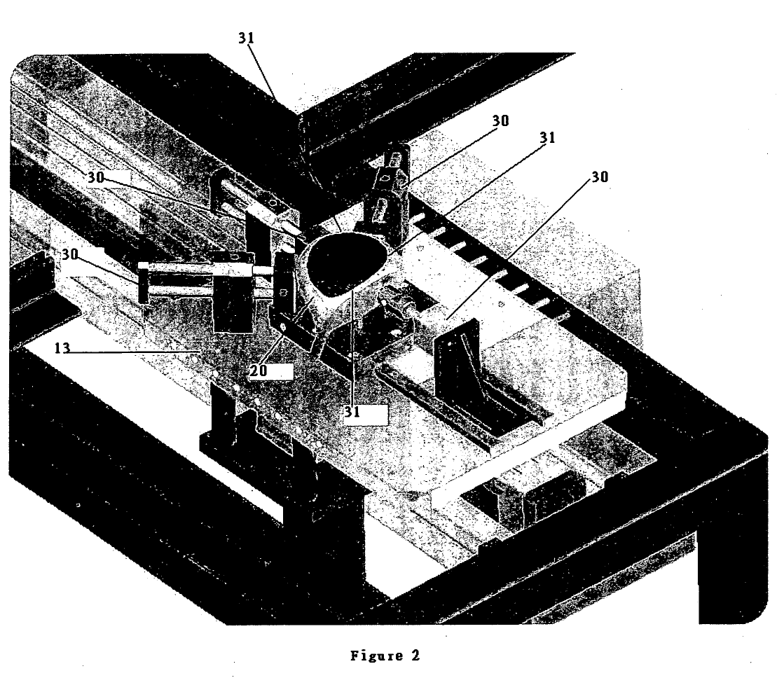

FIG. 2 is a view, in use, of part of the welding system of FIG. 1; and

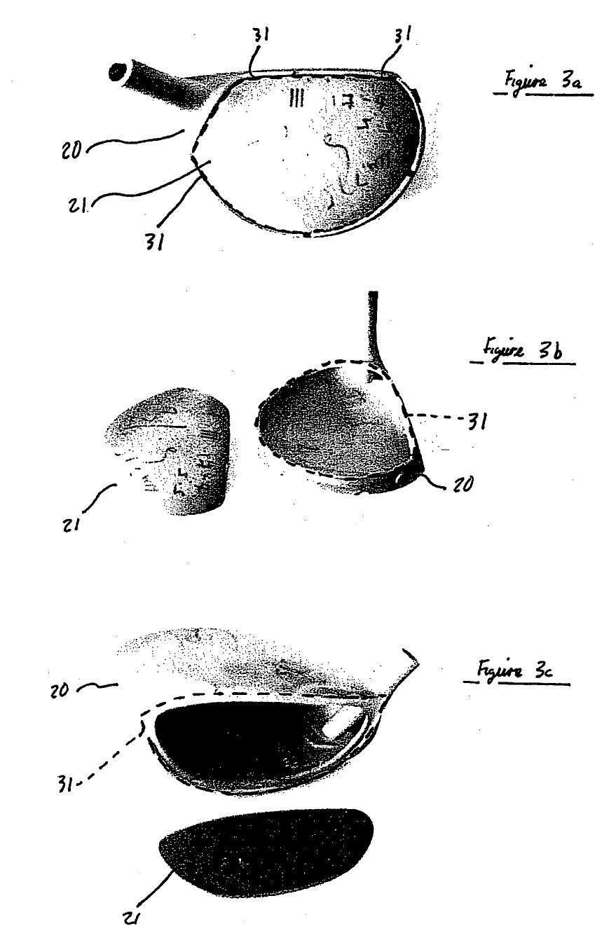

FIGS. 3a, 3b and 3c show the heads of golf clubs to be welded by the system and method according to the present invention.

FIG. 1 shows a block diagram of a welding system, indicated generally at 1. The welding system 1 is provided with a number of system components, such as, a welding torch 2 (welding device 2), a laser tracking device 3 and a smart box 4 (controller module 4). In addition, the welding system 1 includes a robotic arm 5, an auto work piece feeder or conveyor 6, a wire feeder 7, a welding parameter controller 8, a robotic arm controller 9, power sources 10 and 11, a fixture 13 for location of the one or more work pieces during welding, and gas source 12. Lines between respective system components shown in FIG. 1, unless otherwise stated, provide channels of communication, such as, electrical and/or mechanical communication.

The smart box 4 is provided with a processor and a memory and provides control to all operations of the welding system, including the welding parameter controller 8 and the robotic arm controller 9. In particular, the smart box 4 sends data to, and receives data from, the other system components. In operation, the smart box may require specific user input and/or run pre-programmed actions. The smart box is also used to analyse data received from the system components to determine optimum welding operating parameters. For example, data signals 3a received directly from the laser tracking device 3 can be analysed to determine the optimum welding operating parameters and data signals can be sent to the welding parameter controller 8 and the robotic arm controller 9 to implement the optimum welding operating parameters.

Both the welding torch 2 and the laser tracking device 3 are mounted to the robotic arm 5. The welding torch 2 is preferably capable of gas or arc welding, for example, MIG (metal inert gas), laser, plasma or TIG (tungsten inert gas) welding.

The laser tracking device 3 is a detection device, such as a Servo Robot MINI-I 60, which includes a laser sensor (laser camera) and a controller module, and is capable of tracking the weld path and determining variations in the weld path such as the location, path, size, orientation, depth and/or shape of the weld to be produced. In addition, information relating to the determined variations is fed directly to the smart box 4.

The robotic arm 5 is a standard-type robotic arm having typical movement characteristics of up and down, left and right (multiple degrees of freedom). In addition, the arm is provided with a head which may move individually from the rest of the robotic arm. Preferably, the laser tracking device 3 is mounted to a front of the head of the robotic arm 3—so that tracking of the weld path can occur before welding takes place—and the welding torch 2 is mounted to a rear of the head of the robotic arm 5. In addition, the head of the robotic arm is provided with a wire feeder 7 which is located in a position between the laser tracking device 3 and the welding torch 2. The wire feeder 7 feeds to a weld an amount of wire dependant upon the determined variations.

Power source 10 is provided to supply electrical power to the robotic arm 5, including the laser tracking device 3 and the wire feeder 7. Power source 11 provides electrical power to the welding torch 2.

The welding parameter controller 8 is provided to control operation of the welding torch 2 by interaction with the power source 11. Such interaction can alter the current and/or voltage supplied to the welding torch 2, for example.

The robotic arm controller 9 is provided to control operation of the robotic arm 5, the laser tracking device 3 and the wire feeder 7 by interaction with the power source 10. In particular, this control allows the robotic arm to move and track a weld path and position the welding torch at a correct distance from the weld. Further, such interaction allows for alteration of the location, path, size, orientation, depth and/or shape of the desired weld. Additionally, speed of movement of the welding torch 2 and, generally, the robotic arm 5 may be altered.

The gas source 12 can provide a torch gas stream 12a and/or an inert gas stream 12b. The torch gas stream 12a is supplied to the welding torch 2, for gas welding to occur, and the inert gas stream 12b is supplied to the fixture 13—in the region that welding of the work piece will take place. When arc welding is used, the gas source 12 only supplies an inert gas (such as argon) via the inert gas stream 12b. The gas flow rates are controlled and depend upon the determined variations, as mentioned above.

The auto work piece feeder 6 provides one or more work pieces, which may be combined, to the fixture 13, at the location of welding.

In use, the welding system is actuated and the auto work piece feeder 6 provides one or more work pieces to the fixture 13. The one or more work pieces can be combined at the fixture 13 or supplied to it in a combined form. The robotic arm 5, having the welding torch 2, the laser tracking device 3 and wire feeder 7, is moved to the location of the fixture 13 and into a start position from where tracking of the weld path can begin. Once tracking of the weld path starts, the laser tracking device 3—located at the front of the robotics arm—tracks a desired weld path. At the same time, the laser tracking device 3 provides real-time data signals 3a (feedback) relating to variations in the weld path to the smart box 4. The smart box 4 analyses the feedback signals 3a from the laser tracking device 3 in a real-time manner and provides data signals to the robotic arm controller 9 and the welding parameter controller 8.

Data signals received by the robotic arm controller 9 and the welding parameter controller 8 provide instructions for optimising the weld to be produced and these instructions are implemented through the controlled actions of the robotic arm 5, the wire feeder 7 and the welding torch 2. In addition, the inert gas flow rate is optimised in accordance with those instructions. Accordingly, the instructions provide for real-time adjustment of the location size, orientation, depth and/or shape of the weld to be produced. In particular, this occurs by the robotic arm controller 9 controlling and adjusting the path of the robotic arm 5. In addition, the height of the welding torch above the weld may be altered in this manner. Therefore, three-dimensional adjustment of the robotic arm 5 and, therefore, the welding torch mounted thereto, can be achieved. Further, the amount of wire applied to the weld by the wire feeder 7 is optimised according to the determined variations. Also, in particular, the welding parameter controller 8 provides adjustment to the current and/or voltage supplied to the welding torch 2. The combined affect of the alterations made by the two controllers 8,9 is to provide an improved weld on the one or more work pieces.

FIG. 2 shows, in particular, the fixture 13, comprising a number of brackets and/or fittings 30 for location of the one or more work pieces which make up the head of a golf club. A body 20 of the golf club head is held by the brackets and/or fittings 30 in the fixture 13 in an upside down manner, which provides a weld path 31 at an uppermost surface, such that welding of the weld path 31 can be achieved.

Preferably, the work piece is one or more parts which combined, at least partially, if not fully, provide the head of a golf club. Owing to the complexity of the shape of a golf club head, and as the head is an enclosed body, the whole head cannot be cast together. Typically, the head is cast in two pieces which are subsequently welded. In one embodiment, the body 20 of the head is provided initially by casting and an insert 21, for location into the body of the head, is provided by a forging process. An opening is located in the body 20 to allow removal of the body from a mould. The insert is located into the opening prior to welding. The parts may be pre-tacked before welding together. Welding of the body 20 and the insert 21 occurs along the path or line of the join between the two parts of the head, which is the weld path 31. FIGS. 3a, 3b and 3c show three versions of body 20 and insert 21 and corresponding weld paths 31.

Advantageously, the welding system and method of the present invention provide for improved quality welds over prior art systems and methods. Further, the improved quality is provided in a speedy manner with a reduction in wastage of consumables.

In an alternative embodiment, the gas flow rate supplied to a gas welder welding torch can be altered depending upon the determined variations mentioned above. In combination with other alterations, this produces an improved weld on the one or more work pieces.

It will also be understood that the invention is not limited in its application to the details of construction and the arrangement of the components set forth above, or as illustrated in the Figures. Also, it is to be understood that the terminology employed herein is for the purpose of description only and is not limiting. The invention may be realised in many different alternative embodiments to that described and illustrated and the true scope and spirit of the invention is as set out in the appended claims.

1. A welding system for welding one or more work pieces, the system comprising:
a welding device;
a laser tracking device; and
a controller module;
wherein, in use of the welding system, the laser tracking device tracks a path of a desired weld and detects real-time variation(s) in the weld path, which variation(s) is/are assessed by the controller module to provide real-time instructions to adjust, where necessary, one or more welding operating parameters.

2. A welding system as claimed in claim 1, wherein the real-time variations is/are selected from location, path, size, orientation, depth and/or shape of the weld to be produced.

3. A welding system as claimed in claim 1, wherein the welding operating parameters are selected from current or voltage supplied to an arc welder, wire feed rate, torch and/or inert gas flow rates, distance of arc from the weld path of the one or more work pieces, tracking of welding device along the weld path, speed of movement of the welding device, and width, orientation, depth and/or shape of weld produced.

4. A welding system as claimed in claim 1, wherein the welding device is an arc welder or gas welder.

5. A welding device as claimed in claim 4, wherein the arc welder is capable of MIG, laser, plasma or TIG welding.

6. A welding system as claimed in claim 1, wherein the welding device further comprises a wire feeder.

7. A welding system as claimed in claim 1, wherein the laser tracking device is a detection device, which comprises a laser sensor (laser camera) and a controller module.

8. A welding system as claimed in claim 1, wherein the laser tracking device and/or the welding device are located upon a movable armature.

9. A welding system as claimed in claim 8, wherein the laser tracking device is mounted to a front of the armature and the welding device is mounted to a rear of the armature.

10. A welding system as claimed in claim 8, wherein the armature is a robotic arm.

11. A welding system as claimed in claim 1, wherein the welding system further comprises one or more work pieces.

12. A welding system as claimed in claim 11, wherein the one or more work pieces may be fit together, to provide a unitary piece after welding.

13. A welding system as claimed in claim 11, wherein the one or more work pieces may be fit together to provide at least part of a head of a golf club.

14. A welding system as claimed in claim 11, wherein the one or more pieces may be fit together to form the whole head of a golf club.

15. A welding system as claimed in claim 1, wherein the welding system further comprises an auto feeder or conveyor for supplying one or more work pieces.

16. A welding system as claimed in claim 1, wherein the welding system further comprises a fixture for location of the one or more work pieces for welding.

17. A welding system for welding one or more parts of a golf club head, the system comprising:
a welding device;
a laser tracking device; and
a controller module;
wherein, in use of the welding system, the laser tracking device tracks a path of a desired weld and detects real-time variation(s) in the weld path, which variation(s) is/are assessed by the controller module to provide real-time instructions to adjust, where necessary, one or more welding operating parameters.

18. A welding system for welding one or more work pieces, the system comprising:
a welding device;
a laser tracking device; and
a controller module;
wherein, in use of the welding system, the laser tracking device tracks a path of a desired weld and detects real-time variation(s) in the weld path, which variation(s) is/are assessed by the controller module to provide real-time instructions to adjust one or more welding operating parameters.

19. A method of welding one or more work pieces comprising, providing a welding device; a laser tracking device; a controller module; and one or more work pieces, wherein, during welding, the laser tracking device tracks a path of desired weld on the one or more work pieces and detects real-time variations in the weld path, data relating to the real-time variations is assessed by the controller module which provides real-time instructions to adjust, where necessary, one or more welding operating parameters.

20. A method of welding as claimed in claim 19, wherein the real-time variations are selected from location, path, size, orientation, depth and/or shape of the weld to be produced.

21. A method of welding as claimed in claim 19, wherein the welding operating parameters are selected from current or voltage supplied to an arc welder, wire feed rate, torch and/or inert gas flow rates, distance of arc from the weld path of the one or more work pieces, tracking of welding device along the weld path, speed of movement of the welding device and width, orientation, depth and/or shape of weld produced.

22. A method of welding as claimed in claim 19, wherein the welding device is an arc welder or a gas welder.

23. A method of welding as claimed in claim 19, wherein the welding device further comprises a wire feeder.

24. A method of welding as claimed in claim 19, wherein the laser tracking device is a detection device, which comprises a laser sensor (laser camera) and a controller module.

25. A method of welding as claimed in claim 19, wherein the laser tracking device and/or the welding device are located upon a movable armature.

26. A method of welding as claimed in claim 25, wherein the laser tracking device is mounted to a front of the armature and the welding device is mounted to a rear of the armature.

27. A method of welding as claimed in claim 19, wherein the armature is a robotic arm.

28. A method of welding one or more parts of a golf club head comprising, providing a welding device; a laser tracking device; a controller module; and one or more parts of a golf club head, wherein, during welding, the laser tracking device tracks a path of desired weld on the one or more work pieces and detects real-time variations in the weld path, data relating to the real-time variations is assessed by the controller module which provides real-time instructions to adjust, where necessary, one or more welding operating parameters.

29. A method of welding one or more work pieces comprising, providing a welding device; a laser tracking device; a controller module; and one or more work pieces, wherein, during welding, the laser tracking device tracks a path of desired weld on the one or more work pieces and detects real-time variations in the weld path, data relating to the real-time variations is assessed by the controller module which provides real-time instructions to adjust one or more welding operating parameters.
